(19) United States
(12) Patent Application Publication
(10) Pub. No.: US 2010/0258694 A1
(43) Pub. Date: Oct. 14, 2010

(54) SUSPENSION DEVICE

(75) Inventor: Klaus Steger, Eiterfeld (DE)

Correspondence Address: SEED INTELLECTUAL PROPERTY LAW GROUP PLLC, 701 FIFTH AVE, SUITE 5400, SEATTLE, WA, 98104, US

(73) Assignee: ONDAL INDUSTRIETECHNIK GMBH, Hunfeld (DE)

(21) Appl. No.: 12/681,073

(22) PCT Filed: Sep. 30, 2008
(86) PCT No.: PCT/EP08/08305

§ 371 Date: Jun. 21, 2010

(30) Foreign Application Priority Data
Oct. 10, 2007 (DE) 10 2007 048 598.2

(51) Int. Cl. F16M 13/00

(52) U.S. Cl. 248/276.1

(57) ABSTRACT

The present invention concerns a suspension device for free positioning of equipment in rooms used for medical purposes. Multiple open-profile links, comprising a central link (160) for attachment on an axis, intermediate links (150), and an end link (140) are serially connected to one another. Each profile of the links comprises at least one indentation (30). The indentations (30) of the profiles are configured for accommodation of a cable.

In rooms used for medical purposes, suspension devices are conventionally employed, which make it possible to mount equipment to the walls or ceilings. These mounting devices have a multitude of advantages. On the one hand, they provide greater floor clearance. This is very advantageous for reasons of hygiene because during cleaning of the treatment rooms, equipment does not have to be moved and no cables or hoses lie on the floor. On the other hand, they enable the free positioning of the equipment within the respective operating ranges.

### Prior Art

An example of a known apparatus which satisfies the purpose described above is illustrated in FIG. 1. The apparatus has three axes 1-3 for horizontal positioning and one axis 4 for vertical positioning. The device is secured to the wall or ceiling via a vertical axis 1, also called central axis. Connected with this axis is an extension arm 5 which is moveable horizontally. Depending on the required operating radius, the device can be fitted with various length extension arms. A joint with two axes is fixed on the extension arm, in which one axis 4 is oriented horizontally and a further axis 2 vertically. A spring arm 6 is connected with this joint. By virtue of the two axes 2 and 4 in the adjacent joint, this spring arm 6 can be moved vertically as well as horizontally. Medical equipment is attached at the side of the spring arm opposite to the extension arm. The spring arm has a further vertical axis 3. The spring arm is constructed such that both vertical axes 2 and S always remain parallel to one another.

The extension arm 5 in this device has a hollow section. The equipment cables are laid within the extension arm.

The laying of the cables typically takes place during the assembly at the factory and is a difficult business due to the rigid and closed device. A subsequent laying of additional lines is, for the most part, not possible without a disassembly of the device. As a result, subsequently installed lines are often attached externally of the device. In premises used for medical purposes, this is hygienically questionable.

Furthermore, although each desired position within a particular radius is able to be reached, the path to the desired position is not always clear or intuitive. The reason for this is the necessary combination of movements of the long, rigid extension arm by means of the vertical rotational axes. As a consequence, the user must devote a large amount of his attention to the movement of the equipment and the individual vertical axes.

A motorisation of the movements of the suspension device is hindered by the above- described arrangement. This is attributable to the necessary automation of the complicated movement sequences and the large movement ranges of the individual elements. Because a large rotational radius must also be provided for each vertical axis, the selection of the motors is additionally complicated.

To adapt the extension arm to the fields of application with their various operating ranges, various length extension arms are simply produced. This has the disadvantage that a new part must be produced for each desired length. This is reflected either in higher production costs and a smaller selection of lengths.

It is an object of the present invention to provide an improved suspension device which is more manoeuvrable, enables a simple and hygienic guiding of cables, and is more economical to manufacture.

This object is solved by a suspension device according to claim 1. In order to solve the above-described problems, the horizontal extension arm of the present invention is composed of many serially linked elements. With the previous suspension devices, the horizontal extension arm is implemented rigid and closed. With the present invention, the extension arm is replaced by an assembly of multiple intermediate elements, which respectively comprise two vertical axes. In addition to the intermediate elements, each assembly still has a central element for connection to a central axis as well as an end element for mounting of the equipment or a spring arm. All elements are characterized in that they have an open profile, such as e.g. a “T- ” or an I-profile. The indentations of these open profiles are suitable for the accommodation of the equipment cables 180 and, for hygienic reasons, are covered with removable flexible coverings 190. The at least one indentation of each open profile is preferably open on the side. The indentations of the open profile elements are preferably therefore also serially linked together.

There also exists the possibility that the intermediate elements as well as the end element are differently dimensioned corresponding to their bending load. That is, the assembly would be dimensioned smaller towards the end element because towards the end element the bending load decreases. The material usage can thereby be reduced.

The advantage with the simpler and more intuitive operation arises through the number of elements and the thereby increased number of vertical axes. Even when the rotation per axis is limited depending on the embodiment, the higher number of axes leads to a substantially simpler operation. The user can now guide the apparatus on a direct path to the desired position without having to concentrate on the suspension device. The required coordination of the axes as with the previous suspension device is no longer necessary.

In the event of an automation, the selection of the motors is simplified by the smaller rotational radii of the individual vertical axes. Because the number of the motors necessarily increases, one may achieve the desired manoeuvrability also with small motors.

The requirements of particular operating ranges can be ensured with this invention through a differing number of intermediate elements without substantial cost. By the additional insertion of an intermediate element, the radius can be extended, e.g. from L1 to L2, without difficulty. This is, above all for production-related reasons, a decisive advantage because the number of the individual components to be produced is now minimized. The manufacturing costs would thereby be reduced.

The indentations of the open-profile elements are very well suited to the accommodation of the equipment cables. The cables can be attached at the sides of the T- or I-profiles without difficulty. The removable flexible coverings fix the cables in the indentations. By virtue that the coverings are detachable, a subsequent attachment of cables can be accomplished without difficulty. Furthermore, the coverings reduce the exposed areas. This is advantageous for the high hygienic requirements within rooms used for medical purposes, because they are much easier to clean and unhygienic dirty corners therefore do not arise.

### BRIEF DESCRIPTION OF THE DRAWINGS

FIG. 1 shows a suspension device which corresponds to the prior art.

FIG. 2 shows an intermediate link of a suspension device according to a preferred embodiment of the present invention.

FIG. 3 shows a central link of the suspension device according to the preferred embodiment of the present invention.

FIG. 4 shows an end link of the suspension device according to the preferred embodiment of the present invention.

FIG. 5 shows two different length link assemblies of the suspension device according to the invention from the birds-eye perspective.

FIG. 6 shows the perspective view of an assembly of two different length linkage devices of the suspension device according to the invention.

FIG. 7 shows a linkage assembly including the cables and the flexible coverings according to the preferred embodiment of the present invention.

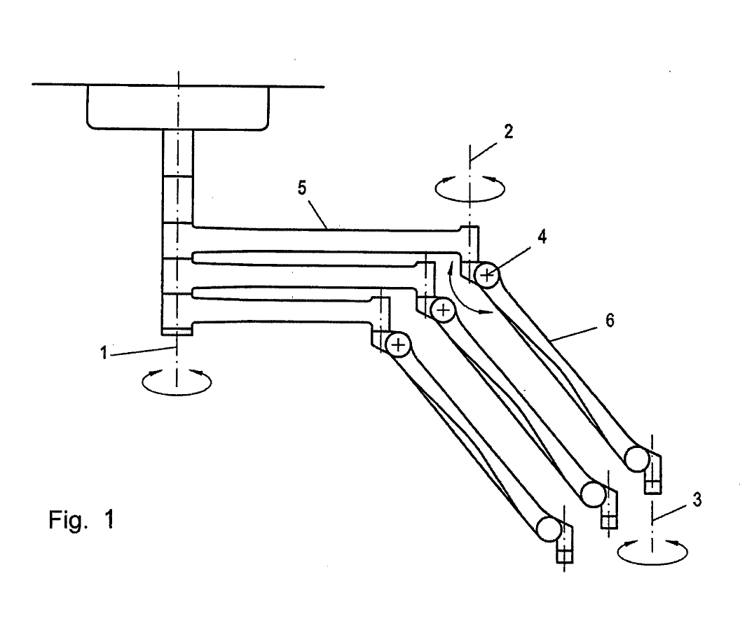

### DETAILED DESCRIPTION OF THE PREFERRED EMBODIMENT

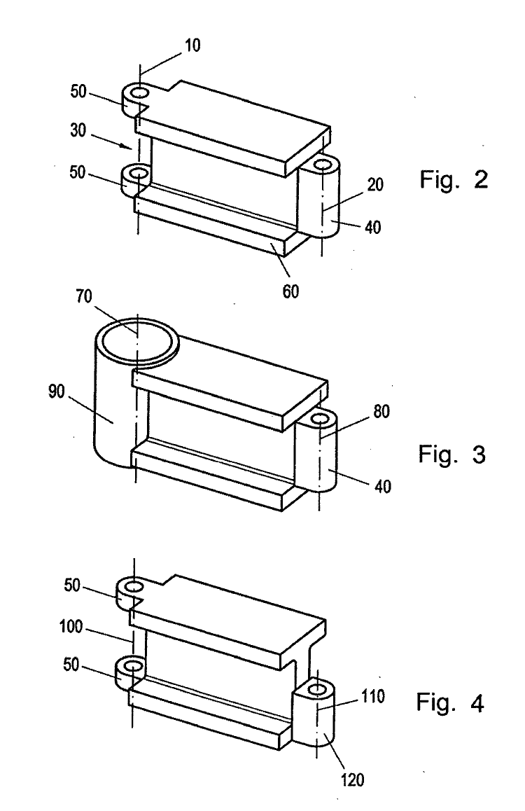

In FIG. 2, an intermediate link having an I-profile is shown. Vertical axes 10 and 20 are located on both sides of the intermediate link. Further, the intermediate link comprises laterally open indentations 30, which extend along the intermediate link for accommodation of one or more equipment cables. By means of pins, which are positioned along the respective vertical axes, the serially arranged intermediate links are connected with one another. Hinges 40 and 50, which partially encompass the vertical axes 10 and 20, are located at the respective ends of the intermediate link. The hinges 40 and 50 are constructed so that they fit into one another or interleave when two links are attached to one another. The two hinges 50 are constructed thinner than the hinge 40. The reason for this is that they are located further removed from a horizontal central plane. The horizontal central plane is located between the upper and lower surfaces of the intermediate link; it is arranged parallel to the upper and lower surfaces of the intermediate link. Through the greater distance to this plane, the hinges 50 have a greater leverage effect to counteract the bending forces. This has the result that the horizontal forces that act upon the hinges are reduced. The hinge 40 lies directly on the central plane of the link. This raises the horizontal forces which act upon the hinge. The hinge 40 is therefore longer than the hinges 50.

The same principal is also responsible for the selection of the I-profile. The cross-sectional area is proportional to the bending force. The distance of the area to the central plane is also proportional to the bending force. As a result, the same bending force can be obtained with a smaller area when the area is further spaced from the central plane. The I-profile has therefore been selected because a large proportion of the area in the cross-section of the I-profile has the greatest possible spacing to the central plane. This makes the I-profile particularly resistant with respect to the bending forces.

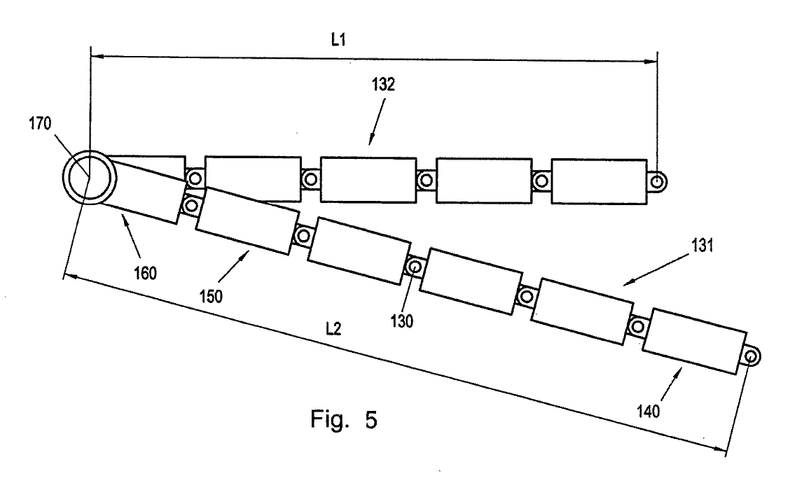

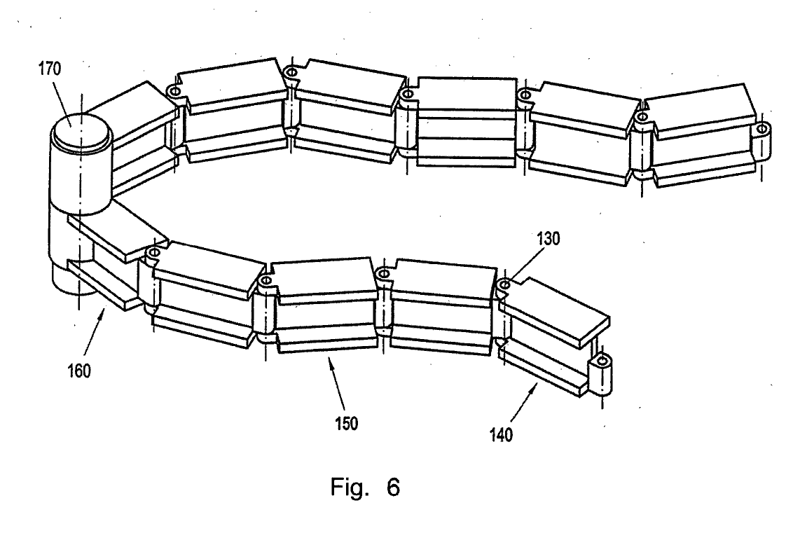

In FIG. 3, a central link is visible. It also has two axes, the central axis 70 and the vertical axis 80. The end of the central link in which the central axis 70 is located, contains hinge 90, which is oriented in the direction of the central axis 70. With this hinge, the entire extension arm is suspended on a journal 170 (FIG. 6). The opposite end of the central link is configured exactly like the end of the intermediate link in which the vertical axis 20 is located. It has the same hinge 40. This end of the central link is connected via a pin 130 (FIG. 5) with that side of the intermediate link that has the hinge 50 (FIG. 2). The pin forms the vertical axis 80. The intermediate link is rotatably mounted about the central axis 80.

In FIG. 4, an end link is shown. It also has two axes, the vertical axis 100 and the end axis 110. The end of the end link in which the vertical axis 100 is located is formed exactly like the end of the intermediate link in which the vertical axis 10 is located. It has the same hinge 50. This end of the end link is connected with an intermediate link via a pin, and indeed with the side of the intermediate link that comprises the hinge 40. The other end of the end link has hinge 120, through which the end axis 110 runs. At this end axis the equipment or the spring arm is mounted by means of a further pin.

In FIG. 5, two extension arms 131 and 132 composed of the different links are shown from above. Here is illustrated how simply the length of the extension arm can be varied by the insertion or removal of an intermediate link 150. At one end of the figure, a journal 170 is illustrated. This journal 170 is normally fixed to a wall or ceiling. The central link 160 is placed onto the journal on one side and, on the other side, is connected with a series of intermediate links 150 via pins 130. At the end of the extension arm, the end link 140 is located.

In FIG. 6, the same extension arms 131 and 132 from FIG. 5 are visible in perspective. The joints here are somewhat pivoted relative to one another in order to clarify the manoeuvrability of the extension arm.

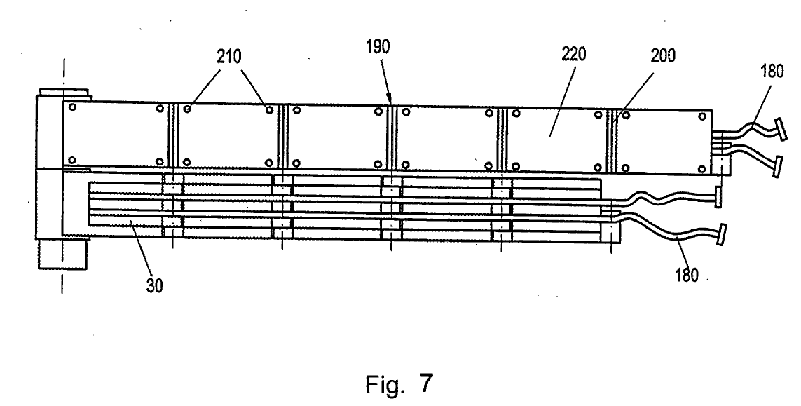

In FIG. 7, the side view of the extension arms 131 and 132 from FIG. 5 is shown. In the lower extension arm is additionally illustrated how the cables 180 are laid within the indentations of the I-profile 30. The cables 180 can be very easily placed into the laterally open indentations 30 of the open-profile links. In the upper extension arm, the flexible coverings 190 are also visible. The indentations of the open-profile links are covered by the flexible coverings. The cables located therein are thereby secured. The coverings consist of relatively rigid covering plates 220, which are attached to each link by means of pins or clips 210. The intervals 200 between the plates are made of flexible material in order not to restrict the freedom of movement of the individual links relative to one another.

Reference numerals

1. Axis 1 (Central axis)

2. Axis 2

3. Axis 3

4. Axis 4

5. Extension arm

6. Spring arm

10. Vertical axis 10

20. Vertical axis 20

30. Indentation of the open profile

40. Hinge 40

50. Hinge 50

60. Bending force bearing area

70. Central axis 70

80. Vertical axis 80

90. Hinge 90

100. Vertical axis 100

110. End axis 110

120. Hinge 120

130. Pin

131. Extension arm 131 with length L1

132. Extension arm 132 with length L2

140. End link

150. Intermediate link

160. Central link

170. Journal

180. Cable

190. Flexible covering

200. Flexible intervals between coverings

210. Covering pins

220. Covering plates

1. A suspension device for free positioning of equipment,
characterized in that
multiple open-profile elements, comprising a central element (160) for mounting on an axis, intermediate elements (150), and an end element (140), are serially connected to one another, wherein each profile of the elements comprises at least one indentation (30) and the indentations (30) of the profiles are suitable for accommodating a cable.

2. Suspension device according to claim 1, wherein the indentations (30) are coverable with flexible coverings (190).

3. Suspension device according to claim 1, wherein the central element (160) is mounted on a central axis (70) and the central element (160) is rotatable about the central axis and also displaceable along the central-axis.

4. Suspension device according to claim 1, wherein each intermediate element respectively comprises two vertical rotational axes.

5. Suspension device according to claim 1, wherein each element can have a T-profile, an I-profile or H-profile.

6. Suspension device according to claim 1, wherein the end element (140) is dimensioned smaller corresponding to the lower bending loads and the intermediate elements (150) are dimensioned smaller towards the end element corresponding to the reducing bending loads, wherein the type of dimensioning corresponds to the resistance with respect to the bending loads.

7. Suspension device according to claim 1, wherein the length of the apparatus arm is variable by the insertion and removal of intermediate elements.
